(19) United States
(12) Patent Application Publication
(10) Pub. No.: US 2010/0189855 A1
(43) Pub. Date: Jul. 29, 2010

(54) Method of Making a Beverage Comprising Fruit and Milk

(75) Inventor: Shannan E. Guck, Windsor, CO (US)

Correspondence Address: BAKER BOTTS L.L.P., 2001 ROSS AVENUE, SUITE 600, DALLAS, TX, 75201-2980, US

(73) Assignee: WhiteWave Services, Inc., Dallas, TX (US)

(21) Appl. No.: 12/558,269

(22) Filed: Sep. 11, 2009

Related U.S. Application Data
(60) Provisional application No. 61/147,640, filed on Jan. 27, 2009.

(51) Int. Cl. A23L 2/68; A23L 2/52; A23C 3/02; A23C 3/00; A23L 2/02

(52) U.S. Cl. 426/311; 426/330.2

(57) ABSTRACT

A method of making a beverage is disclosed. The method comprises mixing water and pectin to form a pectin slurry. Milk is mixed with the pectin slurry. White grape juice concentrate is mixed to the milk and pectin slurry until a stable mixture is achieved. Phosphoric acid is added to reduce the pH level to between approximately 4.8 and approximately 5.2, and citric acid is added to reduce the pH level to between approximately 3.8 and approximately 4.1.

### RELATED APPLICATIONS

This application claims the benefit under 35 U.S.C. §119(e) of U.S. Provisional Application Ser. No. 61/147,640 filed Jan. 27, 2009.

### TECHNICAL FIELD

This disclosure relates generally to beverages, and more specifically to a method of making a beverage comprising fruit and milk.

### BACKGROUND

Consuming fruits and milk provides a multitude of health benefits. Fruits and fruit juices may provide fiber and numerous vitamins. Milk may provide calcium, protein, and additional vitamins. It may be desirable to produce a beverage that provides the health benefits of both fruits and milk. However, due to the acidic nature of many fruits, it may be difficult to produce a stable beverage comprising fruit and milk.

### SUMMARY OF EXAMPLE EMBODIMENTS

The present disclosure is directed to a method for making a beverage comprising fruit and milk. The teachings of the present disclosure may allow for a stable beverage that provides a full serving of fruit and a full serving of milk.

In accordance with a particular embodiment of the present disclosure, a method of making a beverage is disclosed. The method comprises mixing water and pectin to form a pectin slurry. Milk is mixed with the pectin slurry. White grape juice concentrate is mixed to the milk and pectin slurry until a stable mixture is achieved. Phosphoric acid is added to reduce the pH level to between approximately 4.8 and approximately 5.2, and citric acid is added to reduce the pH level to between approximately 3.8 and approximately 4.1.

According to an alternative embodiment of the present disclosure, a method of making a beverage is disclosed. The method comprises mixing water and milk to create a liquid mixture. A fiber source, a gellan gum, and a carrageenan are mixed to create a dry mixture. The liquid mixture and dry mixture are mixed together, and cocoa powder is added. Potassium hydroxide is added to raise the pH level to between approximately 7.2 and approximately 7.8, and white grape juice concentrate is added to lower the pH level to between approximately 6.6 and approximately 7.1.

Technical advantages of particular embodiments of the present disclosure include creating a stable beverage that provides a full serving of both fruit and milk. Further technical advantages of particular embodiments include the production of a beverage with extended shelf life, along with a desirable flavor and mouth feel.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a flow diagram illustrating a method for making a beverage comprising fruit and milk according to particular embodiments;

FIG. 2 is a flow diagram illustrating a method for making a beverage comprising fruit and milk according to particular embodiments; and

FIG. 3 is a flow diagram illustrating a method for making a beverage comprising fruit and milk according to particular embodiments.

### DETAILED DESCRIPTION

Due to the various health benefits of fruit and milk, it may be desirable to produce a single-serving beverage that provides both a full serving of fruit and a full serving of milk. As used throughout this disclosure, “one serving” may mean at least that amount defined by the U.S. Department of Health and Human Services and the U.S. Department of Agriculture. For instance, “one serving” of milk may provide the nutritional benefits of at least one cup of milk. Additionally, “one serving” of fruit may provide the nutritional benefits of at least one-half cup of fruit. Providing full servings of both fruit and milk in a single beverage may be difficult due to the conflicting natures of milk and fruit products, as the acidic nature of fruit may result in curdling of any milk to which it is added.

In accordance with the teaching of the present disclosure, a method for making a beverage comprising fruit and milk is provided. An object of the present disclosure is to provide a single beverage that provides a full serving of fruit and a full serving of milk.

According to particular embodiments of the present disclosure, a method of making a beverage is disclosed. The method comprises mixing water and pectin to form a pectin slurry. Milk is mixed with the pectin slurry. White grape juice concentrate is mixed to the milk and pectin slurry until a stable mixture is achieved. Phosphoric acid is added to reduce the pH level to between approximately 4.8 and approximately 5.2, and citric acid is added to reduce the pH level to between approximately 3.8 and approximately 4.1.

According to alternative embodiments, the method comprises mixing water and milk to create a liquid mixture. A fiber source, a gellan gum, and a carrageenan are mixed to create a dry mixture. The liquid mixture and dry mixture are mixed together, and cocoa powder is added. Potassium hydroxide is added to raise the pH level to between approximately 7.2 and approximately 7.8. White grape juice concentrate is added until the pH level is lowered to between approximately 6.6 and approximately 7.1.

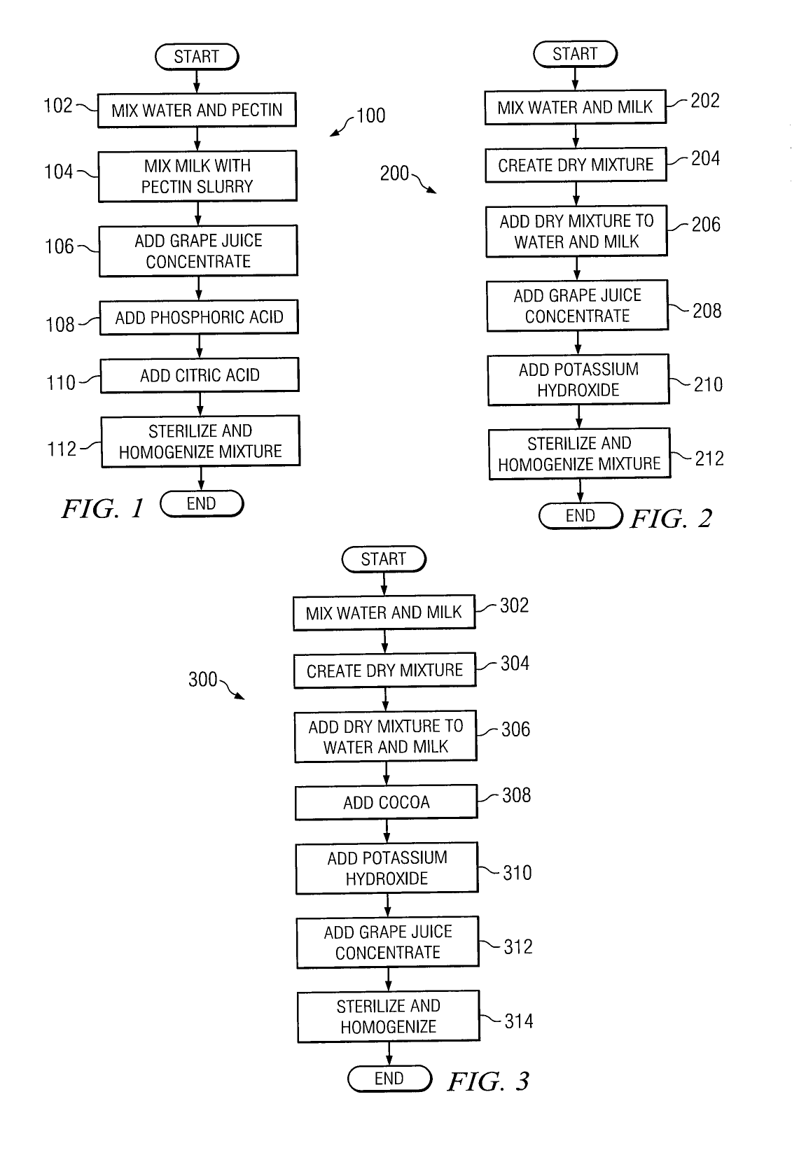

FIG. 1 a flow diagram illustrating a method for making a beverage comprising fruit and milk according to particular embodiments, generally designated by reference numeral 100. This method may be employed for particular beverages that will be fruity or acidic in flavor. The method begins at step 102, where water and pectin are blended to produce a pectin slurry. Pectin may act as a stabilizer, preventing the curdling reaction between milk and an acidic fruit juice. According to particular embodiments, the pectin may be GENU® pectin type YM 100-L. This particular type of pectin is marketed and distributed by CP Kelco ApS. According to alternative embodiments, various other kinds of pectins may be employed. According to particular embodiments, step 102 may be performed with water that is within a particular predefined temperature range. The predefined temperature range may be selected to allow the pectin to fully hydrate in the water. In particular embodiments, this temperature range may be approximately between 80 and 110 degrees Fahrenheit. According to alternative embodiments, water within a different temperature range may be used.

After the pectin and water are combined, the two may be blended until the pectin is hydrated. According to particular embodiments, this may be accomplished using a standard high speed shear mixer operating for some predefined period of time (e.g., approximately five minutes). The predefined time may be the amount of time for the pectin to fully hydrate in the water. This time may vary depending on other various factors. According to particular embodiments, a visual inspection may be used to verify that the pectin is hydrated. According to alternative embodiments, other mixing means may be employed to hydrate the pectin and provide a pectin mixture or “slurry.”

At step 104, the pectin slurry is combined with milk. According to particular embodiments, skim milk or other low-fat milk may be used. The use of low-fat milk may be used primarily for health concerns. According to alternative embodiments, other types of milk may also be used. Regardless of the type of milk used, it should be maintained at cold temperatures to prevent curdling. According to particular embodiments, the temperature may be mandated by the Food and Drug Administration or similar administrative body. According to specific embodiments, the milk should be maintained below 41 degrees Fahrenheit during processing. As a result, the subsequent steps may be performed in a chilled mix tank that is jacketed or insulated to maintain appropriate temperatures. After the pectin slurry and milk are combined in the chilled tank, the resulting mixture is stirred for some pre-defined amount of time (e.g., approximately five minutes) until the two are well blended. According to particular embodiments, the two are well blended when the pectin fully surrounds and protects the milk proteins. After this occurs, additional ingredients, such as flavoring, fiber, or vitamins may also be added.

This mixing step of 104 may be performed by hand or using a low-speed mixer. The stirring process of step 104 may also result in some foaming. This may be particularly true for mixtures using low-fat milk. According to particular embodiments, antifoam or defoamers may be employed to reduce or minimize this foam. According to more particular embodiments, the antifoam may be a non-silicon based antifoam.

At step 106, fruit juice is added to the pectin slurry-milk combination. The fruit juice may be added slowly, while stirring with a high-shear mixer, until well blended. According to particular embodiments, the fruit juice is white grape juice concentrate. According to more particular embodiments, the concentrate may have a concentration level of 68 degrees Brix. According to alternative embodiments, juice concentrate having different levels of concentration may be used. The concentration level of the juice concentrate may be selected based on volume considerations.

After these steps have been completed, the pH level may be too high to provide a desired acidic, fruity flavor. According to particular embodiments, the pH level of the mixture may be adjusted. This may often be accomplished through the addition of one or more acids. At step 108, phosphoric acid is added to the mixture to reduce the pH level. According to particular embodiments, the phosphoric acid may be in liquid form, comprising approximately 86% acid. In alternative embodiments, different forms of acids may be used, such as powdered forms. According to alternative embodiments, different acids and/or concentrations may also be used. After the phosphoric acid is added to the mixture, sufficient time should be allowed for pH calibration, as is well known in the art. According to particular embodiments, this may take approximately five minutes. According to particular embodiments, the phosphoric acid may reduce the pH level of the mixture to a range of approximately 4.8 to 5.2. According to more particular embodiments, it may reduce the pH level to approximately 5.0. However, milk products may be unstable in a pH range of 4.6 to 6.1. Accordingly, the pH may be reduced again.

After sufficient time has passed for pH calibration due to the phosphoric acid, citric acid is added at step 110. According to particular embodiments, the citric acid may be in liquid form, comprising approximately 50% acid. In alternative embodiments, different forms of acids may be used, such as powdered forms. According to alternative embodiments, different acids and/or concentrations may also be used. This may further reduce the pH level of the mixture to within a range of approximately 3.8 to 4.1, at which milk products are generally stable. According to more particular embodiments, it may reduce the pH level of the mixture to approximately 4.0. Values below 3.8 may result in an undesirable flavor that may be deemed too sour. Values between 4.1 and 6.6 may result in precipitation of the milk proteins in the mixture. This may result in a gritty or grainy texture that may provide undesired “mouth feel.” Similar to step 108, sufficient time should be allowed for pH calibration of the mixture. Calibration may occur when there are minimal granules or solids in the mixture. According to particular embodiments, this may take approximately five minutes. According to the illustrated embodiment, two different acids are employed for pH adjustment. According to this particular embodiment, these two acids may provide the desired pH level while maintaining a desirable flavor. According to alternative embodiments, different combinations of acids may be employed.

At step 112, after the mixture has reached the desired pH level, it may be sterilized and homogenized. According to particular embodiments, the mixture may be sterilized using ultra-high temperature processing (UHT). This process heats the mixture to a very high temperature for a short time and may provide sterilization of any potential spores in the milk. This UHT may allow the resulting beverage to have extended shelf life, as opposed to “fresh” milk products, which require refrigeration and still have limited shelf lives.

Additionally, the resulting mixture may be homogenized. Homogenization breaks up fat globules in cream, allowing them to remain suspended evenly in milk. This may prevent the cream from separating out and floating to the surface of milk. This may also allow the resulting beverage to have an extended shelf life. Homogenization may be accomplished by passing the liquid under high pressure through a small orifice. According to particular embodiments, homogenization may be accomplished using two stages, each with a different pressure. According to specific embodiments, at the first stage, the pressure may be approximately 2000 pounds per square inch (psi), and at the second stage, the pressure may be approximately 500 psi. According to particular embodiments, the UHT and homogenization processes may be combined into a single step. Alternatively, they may be performed separately.

FIG. 2 a flow diagram illustrating a method for making a beverage comprising fruit and milk according to particular embodiments, generally designated by reference numeral 200. This method may be employed for particular beverages that will have chocolate-based flavors. The method begins at step 202, where water and milk are mixed together until well blended. This may be performed by hand, or using a low-speed mixer. According to particular embodiments, skim milk or other low-fat milk may be used. The use of low-fat milk may be used primarily for health concerns. According to alternative embodiments, other types of milk may also be used. Regardless of the type of milk used, it should be maintained at cold temperatures to prevent curdling. According to particular embodiments, the temperature may be mandated by the Food and Drug Administration or similar administrative body. According to specific embodiments, the milk should be maintained below 41 degrees Fahrenheit during processing. As a result, the subsequent steps may be performed in a chilled mix tank that is jacketed or insulated to maintain appropriate temperatures.

The stirring process of step 202 may result in some foaming. This may be particularly true for mixtures using low-fat milk. According to particular embodiments, antifoam or defoamers may be employed to reduce or minimize this foam. According to more particular embodiments, the antifoam may be a non-silicon based antifoam.

At step 204, a “dry” mixture is created separately from the liquid milk-water mixture. This dry mixture may comprise a fiber source and one or more stabilizers. The fiber source may be any source for providing soluble fiber in a beverage. The fiber may also help to disperse the stabilizers within the mixture, avoiding clumps. According to particular embodiments, this may be provided through the use of NutraFlora®, a natural prebiotic fiber marketed by GTC Nutrition. According to alternative embodiments, different fiber sources may be used.

As with the process described by FIG. 1, stabilizers help to prevent curdling reactions between acidic fruit sources and milk. Stabilizers may often come in the forms of gums. In addition to stabilizing properties, gums may also thicken the mixture for a better mouth feel. According to particular embodiments, the dry mixture may include two stabilizers—a gellan gum and a carrageenan. Gellan gum may be used to stabilize the mixture without adding viscosity. According to more particular embodiments, the gellan gum may be KELCOGEL® HM-B gellan gum, marketed and distributed by CP Kelco ApS. Carrageenan may be used to thicken the mixture, and may result in a better mouth feel. According to more particular embodiments, the carrageenan may be GENUVISCO® carrageenan type CSM-2, marketed and distributed by CP Kelco ApS. While the illustrated embodiment describes use of a gellan gum and a carrageenan, alternative embodiments may use different types and/or combinations of stabilizers. The type and combination may be selected to achieve desired flavors, textures, and stability of the resulting mixture. Additionally, some stabilizers may react with the calcium in the milk, so non-reactive stabilizers may be selected.

At step 206, after the ingredients are well mixed in the dry mixture, the contents are slowly added to the milk-water blend. During addition of the dry mixture, the milk-water blend should be stirred. This may be performed by hand, or using a low-speed mixer. This process may serve to “texturize” the mixture before cocoa is added to provide a chocolate flavor. According to particular embodiments, the cocoa powder may be ADM De Zaan® D-11-R cocoa powder. According to alternative embodiments, different kinds of cocoa powder may be used. The type of cocoa selected may depend on the desired flavor and color of the finished product. When the cocoa powder is added, additional ingredients, such as flavoring, fiber, or vitamins may also be added.

At step 208, after the dry mixture and cocoa are thoroughly mixed with the milk-water blend, fruit juice is added. The fruit juice may be added slowly, while stirring with a high-shear mixer, until well blended. According to particular embodiments, the fruit juice is white grape juice concentrate. According to more particular embodiments, the concentrate may have a concentration level of 68 degrees Brix. According to alternative embodiments, juice concentrate having different levels of concentration may be used. The concentration level of the juice concentrate may be selected based on volume considerations. The addition of the fruit juice may lower the pH level of the mixture. According to particular embodiments, this may reduce the pH level to approximately 5.5.

As with the process described by FIG. 1, the pH level of the resulting mixture may then be adjusted. However, as the process described by FIG. 2 is directed to chocolate-based flavors, a less-acidic pH level may provide the desired flavor. At step 210, potassium hydroxide is added to the mixture to raise the pH level of the mixture. According to particular embodiments, the potassium hydroxide may be in liquid form, comprising 40% base. In alternative embodiments, different forms of bases may be used, such as powdered forms. According to alternative embodiments, different bases and/or concentrations may also be used. After the potassium hydroxide is added to the mixture, sufficient time should be allowed for pH calibration, as is well known in the art. According to particular embodiments, the potassium hydroxide may increase the pH level of the mixture to a range of 6.6 to 7.1. According to more particular embodiments, it may increase the pH level to approximately 6.8.

At step 212, after the mixture has reached the desired pH level, it may be sterilized and homogenized. According to particular embodiments, the mixture may be sterilized using ultra-high temperature processing (UHT). This process heats the mixture to a very high temperature for a short time and may provide sterilization of any potential spores in the milk. This UHT may allow the resulting beverage to have extended shelf life, as opposed to “fresh” milk products, which require refrigeration and still have limited shelf lives.

Additionally, the resulting mixture may be homogenized. Homogenization breaks up fat globules in cream, allowing them to remain suspended evenly in milk. This may prevent the cream from separating out and floating to the surface of milk. This may also allow the resulting beverage to have an extended shelf life. Homogenization may be accomplished by passing the liquid under high pressure through a small orifice. According to particular embodiments, homogenization may be accomplished using two stages, each with a different pressure. According to specific embodiments, at the first stage, the pressure may be approximately 2000 pounds per square inch (psi), and at the second stage, the pressure may be approximately 500 psi. According to particular embodiments, the UHT and homogenization processes may be combined into a single step. Alternatively, they may be performed separately.

FIG. 3 a flow diagram illustrating a method for making a beverage comprising fruit and milk according to particular embodiments, generally designated by reference numeral 300. This method may be employed for particular beverages that will have chocolate-based flavors. The method begins at step 302, where water and milk are mixed together until well blended. This may be performed by hand, or using a low-speed mixer. According to particular embodiments, skim milk or other low-fat milk may be used. The use of low-fat milk may be used primarily for health concerns. According to alternative embodiments, other types of milk may also be used. Regardless of the type of milk used, it should be maintained at cold temperatures to prevent curdling. According to particular embodiments, the temperature may be mandated by the Food and Drug Administration or similar administrative body. According to specific embodiments, the milk should be maintained below 41 degrees Fahrenheit during processing. As a result, the subsequent steps may be performed in a chilled mix tank that is jacketed or insulated to maintain appropriate temperatures.

The stirring process of step 302 may result in some foaming. This may be particularly true for mixtures using low-fat milk. According to particular embodiments, antifoam or defoamers may be employed to reduce or minimize this foam. According to more particular embodiments, the antifoam may be a non-silicon based antifoam.

At step 304, a “dry” mixture is created separately from the liquid milk-water mixture. This dry mixture may comprise a fiber source and one or more stabilizers. The fiber source may be any source for providing soluble fiber in a beverage. The fiber may also help to disperse the stabilizers within the mixture, avoiding clumps. According to particular embodiments, this may be provided through the use of NutraFlora®, a natural prebiotic fiber marketed by GTC Nutrition. According to alternative embodiments, different fiber sources may be used.

As with the process described by FIGS. 1 and 2, stabilizers help to prevent curdling reactions between acidic fruit sources and milk. Stabilizers may often come in the forms of gums. In addition to stabilizing properties, gums may also thicken the mixture for a better mouth feel. According to particular embodiments, the dry mixture may include two stabilizers—a gellan gum and a carrageenan. Gellan gum may be used to stabilize the mixture without adding viscosity. According to more particular embodiments, the gellan gum may be KELCOGEL® HM-B gellan gum, marketed and distributed by CP Kelco ApS. Carrageenan may be used to thicken the mixture, and may result in a better mouth feel. According to more particular embodiments, the carrageenan may be GENUVISCO® carrageenan type CSM-2, marketed and distributed by CP Kelco ApS. While the illustrated embodiment describes use of gellan gum and carrageenan, alternative embodiments may use different types and/or combinations of stabilizers. The type and combination may be selected to achieve desired flavors, textures, and stability of the resulting mixture. Additionally, some stabilizers may react with the calcium in the milk, so non-reactive stabilizers may be selected.

At step 306, after the ingredients are well mixed in the dry mixture, the contents are slowly added to the milk-water blend. During addition of the dry mixture, the milk-water blend should be stirred. This may be performed by hand, or using a low-speed mixer. This process may serve to “texturize” the mixture before cocoa is added at step 308 to provide a chocolate flavor. According to particular embodiments, the cocoa powder may be ADM De Zaan® D-11-R cocoa powder. According to alternative embodiments, different kinds of cocoa powder may be used. The type of cocoa selected may depend on the desired flavor and color of the finished product. When the cocoa powder is added, additional ingredients, such as flavoring, fiber, or vitamins may also be added.

After the dry mixture and cocoa are thoroughly mixed with the milk-water blend, the pH level of the resulting mixture may then be adjusted. However, as the process described by FIG. 3 is directed to chocolate-based flavors, a less-acidic pH level may provide the desired flavor. At step 310, potassium hydroxide is added to the mixture to raise the pH level of the mixture. According to particular embodiments, the potassium hydroxide may be in liquid form, comprising 40% base. In alternative embodiments, different forms of bases may be used, such as powdered forms. According to alternative embodiments, different bases and/or concentrations may also be used. After the potassium hydroxide is added to the mixture, sufficient time should be allowed for pH calibration, as is well known in the art.

At step 312, after the pH level is increased by the potassium hydroxide, fruit juice is added. According to particular embodiments, the fruit juice may decrease the pH level of the mixture to a range of approximately 6.6 to 7.1. According to more particular embodiments, it may decrease the pH level to approximately 6.8. According to particular embodiments, the fruit juice is white grape juice concentrate. The fruit juice may be added slowly while stirring until well blended. The fruit juice may be added slowly, while stirring with a high-shear mixer, until well blended. According to particular embodiments, the fruit juice is white grape juice concentrate. According to more particular embodiments, the concentrate may have a concentration level of 68 degrees Brix. According to alternative embodiments, juice concentrate having different levels of concentration may be used. The concentration level of the juice concentrate may be selected based on volume considerations.

At step 314, after the mixture has reached the desired pH level, it may be sterilized and homogenized. According to particular embodiments, the mixture may be sterilized using ultra-high temperature processing (UHT). This process heats the mixture to a very high temperature for a short time and may provide sterilization of any potential spores in the milk. This UHT may allow the resulting beverage to have extended shelf life, as opposed to “fresh” milk products, which require refrigeration and still have limited shelf lives.

Additionally, the resulting mixture may be homogenized. Homogenization breaks up fat globules in cream, allowing them to remain suspended evenly in milk. This may prevent the cream from separating out and floating to the surface of milk. This may also allow the resulting beverage to have an extended shelf life. Homogenization may be accomplished by passing the liquid under high pressure through a small orifice. According to particular embodiments, homogenization may be accomplished using two stages, each with a different pressure. According to specific embodiments, at the first stage, the pressure may be approximately 2000 pounds per square inch (psi), and at the second stage, the pressure may be approximately 500 psi. According to particular embodiments, the UHT and homogenization processes may be combined into a single step. Alternatively, they may be performed separately.

Although the present disclosure has been described with several embodiments, a multitude of changes, variations, alterations, transformations, and modifications may be suggested to one skilled in the art, and it is intended that the present disclosure encompass such changes, variations, alterations, transformations, and modifications as they fall within the scope of the appended claims.

What is claimed is:

1. A method for making a beverage, comprising the steps of:
(a) mixing water and pectin to form a pectin slurry;
(b) mixing milk with the pectin slurry;
(c) mixing white grape juice concentrate to the milk and pectin slurry until a stable mixture is achieved;
(d) adding phosphoric acid to reduce the pH level to between approximately 4.8 and approximately 5.2; and
(e) adding citric acid to reduce the pH level to between approximately 3.8 and approximately 4.1.

2. The method of claim 1, wherein the phosphoric acid is added to reduce the pH level to approximately 5.0.

3. The method of claim 2, wherein the citric acid is added to reduce the pH level to approximately 4.0.

4. The method of claim 1, step (a) is performed at a temperature range between approximately 80 degrees and 110 degrees Fahrenheit.

5. The method of claim 1, wherein steps (b)-(e) are performed at a temperature below 41 degrees Fahrenheit.

6. The method of claim 1, wherein the white grape juice concentrate has a Brix level of approximately 68.

7. The method of claim 1, wherein the phosphoric acid is a liquid solution comprising approximately 86% acid.

8. The method of claim 1, wherein the citric acid is a liquid solution comprising approximately 50% acid.

9. The method of claim 1, further comprising adding one or more of flavoring, fiber, or vitamins to the milk and pectin slurry before step (c).

10. A method for making a beverage, comprising the steps of:
(a) mixing water and pectin at a temperature range between approximately 80 degrees and 110 degrees Fahrenheit until the pectin is hydrated, resulting in a pectin slurry;
(b) mixing low-fat milk with the pectin slurry until the pectin surrounds and protects proteins in the milk;
(c) adding one or more of flavoring, fiber, or vitamins to the milk and pectin slurry;
(d) mixing white grape juice concentrate having a Brix level of approximately 68 to the milk and pectin slurry until a stable mixture is achieved;
(e) adding phosphoric acid to reduce the pH level of the stable mixture to between approximately 4.8 and approximately 5.2, wherein the phosphoric acid is a liquid solution comprising approximately 86% acid;
(f) adding citric acid to reduce the pH level of the stable mixture to between approximately 3.8 and approximately 4.1, wherein the citric acid is a liquid solution comprising approximately 50% acid;
(g) sterilizing the stable mixture using ultra-high temperature processing;
(h) homogenizing the stable mixture using a two stage process, wherein the first stage is performed at approximately 2000 psi, and wherein the second stage is performed at approximately 500 psi; and
wherein steps (b)-(f) are performed at a temperature below 41 degrees Fahrenheit.

11. A method for making a beverage, comprising the steps of:
(a) mixing water and milk to create a liquid mixture;
(b) mixing a fiber source, a gellan gum, and a carrageenan to create a dry mixture;
(c) mixing the liquid mixture and dry mixture together;
(d) adding cocoa powder;
(e) adding potassium hydroxide to raise the pH level to between approximately 7.2 and approximately 7.8; and
(f) adding white grape juice concentrate to reduce the pH level to between approximately 6.6 and approximately 7.1.

12. The method of claim 11, wherein the white grape juice concentrate is added to reduce pH level to approximately 6.8.

13. The method of claim 11, wherein steps (a) and (c)-(f) are performed at a temperature below 41 degrees Fahrenheit.

14. The method of claim 11, wherein the white grape juice concentrate has a Brix level of approximately 68.

15. The method of claim 11, wherein the potassium hydroxide is a liquid solution comprising approximately 40% base.

16. A method for making a beverage, comprising the steps of:
(a) mixing water and low-fat milk to create a liquid mixture;
(b) mixing a fiber source, a gellan gum, and a carrageenan to create a dry mixture;
(c) mixing the liquid mixture and dry mixture together, resulting in a texturized mixture;
(d) adding cocoa powder to the texturized mixture, resulting in a cocoa-flavored mixture;
(e) adding one or more of additional flavoring, fiber, or vitamins to the cocoa-flavored mixture;
(f) adding potassium hydroxide to raise the pH level to between approximately 7.2 and approximately 7.8, wherein the potassium hydroxide is a liquid solution comprising approximately 40% base;
(g) adding white grape juice concentrate to reduce the pH level to between approximately 6.6 and approximately 7.1, resulting in a stable mixture, wherein the white grape juice concentrate has a Brix level of approximately 68, result;
(h) sterilizing the stable mixture using ultra-high temperature processing;
(i) homogenizing the stable mixture using a two stage process, wherein the first stage is performed at approximately 2000 psi, and wherein the second stage is performed at approximately 500 psi; and
wherein steps (a) and (c)-(g) are performed at a temperature below 41 degrees Fahrenheit.
